(19) United States
(12) Patent Application Publication
(10) Pub. No.: US 2025/0117914 A1
(43) Pub. Date: Apr. 10, 2025

(54) APPLYING RULES DURING AN INSPECTION MISSION TO DETERMINE AN INSPECTION COLLECTION DATA SET

(71) Applicant: International Business Machines Corporation, Armonk, NY (US)

(72) Inventors: Nir Rozenbaum, Yoqneam Illit (IL); Maroon Ayoub, Fassuta (IL); Nili Guy, Haifa (IL)

(21) Appl. No.: 18/376,759

(22) Filed: Oct. 4, 2023

(51) Int. Cl. G06T 7/00; G06N 20/00

(52) U.S. Cl. CPC G06T 7/0004; G06N 20/00; G06T 2207/30168

(57) ABSTRACT

A computer-implemented method, according to one approach, includes obtaining, on a first edge device, a plurality of artificial intelligence (AI) rules. The method further includes applying, on the first edge device, the AI rules to a plurality of evaluated data samples for determining whether to include the data samples in an inspection collected data set. In response to a determination that a first of the data samples satisfies each of the AI rules, the first data sample is caused to be included in the inspection collected data set. The inspection collected data set is caused to be uploaded to a cloud site. A computer program product, according to another approach, includes a computer readable storage medium having program instructions embodied therewith. The program instructions are readable and/or executable by a first edge device to cause the first edge device to perform any combination of features of the foregoing methodology.

### BACKGROUND

The present invention relates to training and inference obtained by applying artificial intelligence (AI) rules, and more specifically, this invention relates to applying rules during an inspection mission to determine an inspection collection data set for uploading to a cloud site. More specifically, these AI rules are applied to reduce the size of an inspection collected data set, and furthermore to reduce the data size that is uploaded from an edge device to the cloud during an inspection mission.

Data is often collected by edge devices, e.g., computers, phones, etc., and uploaded to a collection of data stored on a cloud server. In some cases, the data is used on the cloud server for AI purposes. An AI pipeline typically includes a pipeline to upload data from these devices to the cloud server, and AI models that are used in order to analyze the data in the cloud server and obtain insights about the collected data.

Edge devices are sometimes used to collect data while performing a predetermined type of inspection, e.g., road and/or pavement inspections, solar panels inspections, manufacturing plant inspections, etc. The collected data may be uploaded to the cloud for relatively heavier analysis for the purpose of detecting defects in an object of interest of the collected data. In some use cases, the AI pipeline includes relatively heavy AI models that cannot run directly on the edge devices that collect the data due to the limited computational resources available on the devices. In other use cases, the data in which the AI model is relatively lightweight, the AI model is able to be run directly on the edge devices collecting the data.

One main aspect of such AI pipelines includes a data acquisition process that is performed by the edge devices at an edge site. The data is typically collected in a non-systematic way. For example, in some use cases, a mobile device may be used to collect the data during which each image is taken while the mobile device is positioned differently. This results in the images being captured with different characteristics which makes it harder to analyze the images and find predefined defects, e.g., specific object(s) that are targeted, in the objects.

In order to be able to detect objects and/or defects in images with different characteristics as described above, conventional techniques sometimes enhance the training data set by creating different variations of the data. This is performed at a training phase in the AI model's lifecycle. For doing so, the training of the cloud AI model is performed not only using the real data, but also using synthetic data generation techniques in order to create synthetic data that can be added to the training set of the AI model. Furthermore, the training of the cloud AI model additionally includes using data augmentation techniques in order to generate different variations of the real data, e.g., noisy data. These techniques make the training data relatively larger in size with many variations, which has some negative implications. For example, a first negative implication includes model complexity. In other words, increasing the relative size of the training dataset may require using a relatively more complex model architecture to achieve relatively better performance. This can lead to relatively higher AI model complexity, a relatively larger AI model size, relatively longer training times for the AI model and relatively longer inference times for the AI model.

Increasing the relative size of the training dataset also results in a relatively increased consumption of computational resources. This is because training models with relatively larger datasets may require relatively more significant computational resources, e.g., such as high-end central processing units (CPUs) and/or graphics processing units (GPUs). This can increase the cost associated with developing and deploying AI models. Additionally, relatively larger models typically consume relatively more computational resources during inferencing. Accordingly, there is a longstanding need for establishing a relatively refined collection of data before uploading inspection data from edge devices to a cloud site.

### SUMMARY

A computer-implemented method, according to various approaches, includes obtaining, on a first edge device, a plurality of AI rules. The method further includes applying, on the first edge device, the AI rules to a plurality of evaluated data samples for determining whether to include the data samples in an inspection collected data set. In response to a determination that a first of the data samples satisfies each of the AI rules, the first data sample is caused to be included in the inspection collected data set. The inspection collected data set is caused to be uploaded to a cloud site.

A computer program product, according to various approaches, includes a computer readable storage medium having program instructions embodied therewith. The program instructions are readable and/or executable by a first edge device to cause the first edge device to perform any combination of features of the foregoing methodology.

A system, according to various approaches, includes a processor, and logic integrated with the processor, executable by the processor, or integrated with and executable by the processor. The logic is configured to perform any combination of features of the foregoing methodology.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a flowchart of a method, in accordance with one approach.

FIG. 3 depicts a comparative overlay, in accordance with one approach.

FIGS. 4A-4B depict data samples, in accordance with several approaches.

FIGS. 5A-5B depict systems, in accordance with several approaches.

FIGS. 6A-6C depict edge device screenshots, in accordance with several approaches.

FIG. 7 depicts a schematic of AI rules being applied to data samples, in accordance with one approach.

FIG. 8 depicts a system for applying rules to determine an inspection collected data set, in accordance with one approach.

FIG. 9 depicts an environment, in accordance with one approach.

FIGS. 10A-10F depict data samples in accordance with several approaches.

FIG. 11 depicts a collection of data samples, in accordance with one approach.

FIG. 12 depicts a table, in accordance with one approach.

FIG. 13 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for applying rules during an inspection mission to determine an inspection collection data set for uploading to a cloud site.

In one general approach, a computer-implemented method includes obtaining, on a first edge device, a plurality of artificial intelligence (AI) rules. The method further includes applying, on the first edge device, the AI rules to a plurality of evaluated data samples for determining whether to include the data samples in an inspection collected data set. In response to a determination that a first of the data samples satisfies each of the AI rules, the first data sample is caused to be included in the inspection collected data set. The inspection collected data set is caused to be uploaded to a cloud site.

As a result of using the method to relatively refine the data samples that are included in the inspection collected data set, the contents of the data samples that are included in the inspection collected data set are vetted to satisfy the predetermined AI rules. Processing resources of the edge device and the cloud site are preserved as a result of deploying the techniques described herein because the amount of data that is ultimately processed and then uploaded from the first edge device to the cloud site is relatively decreased as a result of excluding at least some data samples determined to not satisfy at least one of the AI rules from the inspection collected data set. Processing resources expended in order to apply AI rules have, during testing of the method, been found to be relatively less than the processing resources expended in order to send an unrefined inspection collected data set to the cloud site. This relatively refined inspection collected data set also enables a relatively increased upload speed of the inspection collected data set, based on relatively less data being uploaded. Of course, all of these benefits ultimately cause relatively less data being processed and computed at the cloud site, which results in at least some processing resources that would otherwise be consumed processing the inspection collected data set being preserved, and costs associated with this processing being saved.

The method may further include causing a second of the data samples to be excluded from the inspection collected data set in response to a determination that the second data sample does not satisfy at least one of the AI rules. Processing resources of the edge device and the cloud site are preserved as a result of excluding at least some data samples determined to not satisfy at least one of the predetermined AI rules. More specifically, these processing resources would have otherwise been expended processing and uploading the data samples determined to not satisfy at least one of the predetermined AI rules.

In response to the determination that the second of the data samples does not satisfy a first of the AI rules, the method may include performing an adjustment to cause the second data sample to satisfy the first AI rule, and reapplying the AI rules in response to a determination that the adjustment has been performed. These adjustments advantageously enable the second data sample to conform to all of the AI rules in order to allow incorporation of the updated second data sample, e.g., the second data sample subsequent to the adjustment(s) being performed, to the inspection collected data set.

The evaluated data samples may be images. Several use cases of data uploads to a cloud site include images. Accordingly, the method being configured to evaluate data samples that are images allows for the performance benefits associated with generating the inspection collected data set to be realized in use cases in which evaluated data samples are images.

The AI rules may include the image being evaluated being captured from a predetermined ground sample distance from an object of interest, a predetermined object to background ratio being met, a predetermined lighting condition being met, the object of interest being centered in the image being evaluated, and the object of interest being focused in the image being evaluated. The AI rules may be applied to determine the relatively refined inspection collected data set.

Causing the first data sample to be included in the inspection collected data set may include outputting an instruction to a second edge device to capture the first data sample, where causing the inspection collected data set to be uploaded to the cloud site includes outputting an instruction to the second edge device to upload the inspection collected data set to the cloud site. In some approaches in which capture of the first data sample is delayed until a determination is made that AI rules are satisfied, processing resources that are expended capturing the first data sample are ensured to not be otherwise wasted capturing data contents that do not satisfy the AI rules.

Causing the first data sample to be included in the inspection collected data set includes capturing, by the first edge device, the first data sample, where the inspection collected data set is uploaded to the cloud site by the first edge device. Capturing the first data sample allows for a relatively refined inspection collected data set to be established.

In some use cases, the AI rules are sequentially applied to the first data sample. Sequential application of the AI rules allows for processing resources to be preserved in response to the determination that one of the AI rules is not met. For example, in response to a determination that a first applied one of the AI rules is not met, processing resources that would otherwise be expended applying the second of the AI rules is preserved. In some other use cases, the AI rules are applied in parallel to a second of the data samples. Parallel application of the AI rules advantageously relatively decreases the processing time of applying the AI rules.

A first of the evaluated data samples may be an image and a second of the evaluated data samples may be selected from a thermal reading and an audio clip. Diversification of the type of evaluated data samples allows for a relatively diverse inspection collected data set to be determined.

In another general approach, a computer program product, includes a computer readable storage medium having program instructions embodied therewith. The program instructions are readable and/or executable by a first edge device to cause the first edge device to perform any combination of features of the foregoing methodology. Similar technical effects are obtained.

In another general approach, a system, includes a processor, and logic integrated with the processor, executable by the processor, or integrated with and executable by the processor. The logic is configured to perform any combination of features of the foregoing methodology. Similar technical effects are obtained.

In a preferred approach, a computer-implemented method includes obtaining, on a first edge device, a plurality of AI rules. The method further includes applying, on the first edge device, the AI rules to a plurality of evaluated data samples for determining whether to include the data samples in an inspection collected data set. In response to a determination that a first of the data samples satisfies each of the AI rules, the first data sample is caused to be included in the inspection collected data set. In response to a determination that a second of the data samples does not satisfy at least one of the AI rules, the second data sample is caused to be excluded from the inspection collected data set. The inspection collected data set is caused to be uploaded to a cloud site.

As a result of using the method to relatively refine the data samples that are included in the inspection collected data set, the contents of the data samples that are included in the inspection collected data set are vetted to satisfy the predetermined AI rules. Processing resources of the edge device and the cloud site are preserved as a result of deploying the techniques described herein because the amount of data that is ultimately processed and then uploaded from the first edge device to the cloud site is relatively decreased as a result of the preferred approach above excluding at least some data samples determined to not satisfy at least one of the AI rules from the inspection collected data set.

In one preferred use case approach, a computer-implemented method includes obtaining, on a first edge device, a plurality of AI rules. The first edge device may be a programmable robot. The method further includes applying, on the first edge device, the AI rules to a plurality of evaluated data samples for determining whether to include the data samples in an inspection collected data set. In response to a determination that a first of the data samples satisfies each of the AI rules, the first data sample is caused to be included in the inspection collected data set. The inspection collected data set is caused to be uploaded to a cloud site.

Use cases that have a programmable robot as the first edge device enable the first edge device to capture evaluated data samples again from a different angle in response to a determination that the evaluated data sample does not satisfy each of the AI rules. Accordingly, a relatively refined inspection collected data set is able to be generated and uploaded to the cloud site.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as AI rule application code of block 150 for applying rules during an inspection mission to determine an inspection collection data set for uploading to a cloud site. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

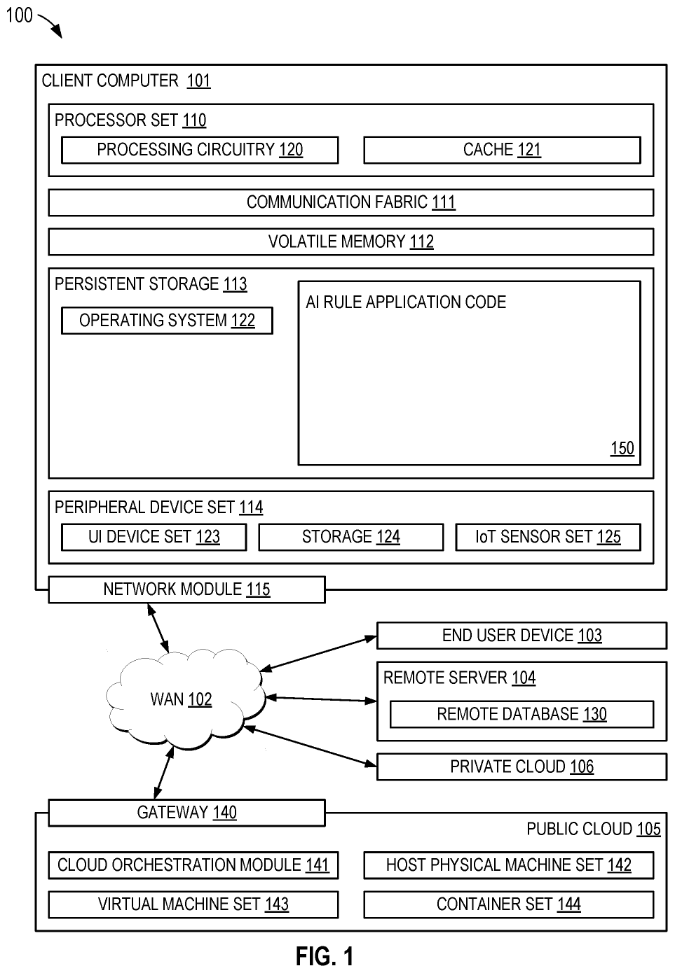

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As mentioned elsewhere above, data is often collected by edge devices, e.g., computers, phones, etc., and uploaded to a collection of data stored on a cloud server. In some cases, the data is used on the cloud server for AI purposes. An AI pipeline typically includes a pipeline to upload data from these devices to the cloud server, and AI models that are used in order to analyze the data in the cloud server and obtain insights about the collected data.

Edge devices are sometimes used to collect data while performing a predetermined type of inspection, e.g., road and/or pavement inspections, solar panels inspections, manufacturing plant inspections, etc. The collected data may be uploaded to the cloud for relatively heavier analysis for the purpose of detecting defects in an object of interest of the collected data. In some use cases, the AI pipeline includes relatively heavy AI models that cannot run directly on the edge devices that collect the data due to the limited computational resources available on the devices. In other use cases the data in which the AI model is relatively lightweight, the AI model is able to be run directly on the edge devices collecting the data.

One main aspect of such AI pipelines includes a data acquisition process that is performed by the edge devices at an edge site. The data is typically collected in a non-systematic way. For example, in some use cases, a mobile device may be used to collect the data during which each image is taken while the mobile device is positioned differently. This results in the images being captured with different characteristics which makes it harder to analyze the images and find predefined defects, e.g., specific object(s) that are targeted, in the objects.

In order to be able to detect objects and/or defect in images with different characteristics as described above, conventional techniques sometimes enhance the training data set by creating different variations of the data. This is performed at a training phase in the AI model's lifecycle. For doing so, the training of the cloud AI model is performed not only using the real data, but also using synthetic data generation techniques in order to create synthetic data that can be added to the training set of the AI model. Furthermore, the training of the cloud AI model additionally includes using data augmentation techniques in order to generate different variations of the real data, e.g., noisy data. These techniques make the training data relatively larger in size with many variations, which has some negative implications. For example, a first negative implication includes model complexity. In other words, increasing the relative size of the training dataset may require using a relatively more complex model architecture to achieve relatively better performance. This can lead to relatively higher AI model complexity, a relatively larger AI model size, relatively longer training times for the AI model and relatively longer inference times for the AI model.

Increasing the relative size of the training dataset also results in a relatively increased consumption of computational resources. This is because training models with relatively larger datasets may require relatively more significant computational resources, e.g., such as high-end CPUs and/or GPUs. This can increase the cost associated with developing and deploying AI models. Additionally, relatively larger models typically consume relatively more computational resources during inferencing. Accordingly, there is a longstanding need for establishing a relatively refined data set before uploading inspection data of an inspection collected data set from edge devices to a cloud site.

In sharp contrast to the deficiencies of the conventional techniques described above, various approaches described herein control a data acquisition process on roaming edge devices in a way that allows collecting only data that is determined to be effective, e.g., high utility data, to its target AI processing pipeline. At a relatively high level, the data acquisition process is controlled at the edge in a way that validates the collected data to ensure that the data that is uploaded to the cloud site is effective for its target AI model that thereafter analyzes the data at the end of the AI pipeline. More specifically, the data acquisition process is controlled by applying AI rules to reduce the size of an inspection collected data set, and furthermore to reduce the data size that is uploaded from an edge device to the cloud during an inspection mission. This is achieved by validating that evaluated data, e.g., every image, matches a predefined set of rules (by using some computer vision and AI capabilities). It should be noted that, because the data acquisition process is controlled as a result of this validation, conventional techniques described elsewhere herein for enhancing a training data set by creating different variations of the data become redundant. This means that training data sizes that are otherwise produced in conventional techniques are reduced as a result of the techniques described herein removing synthetic data and augmented data, without effecting an accuracy of the model thereafter. This also results in relatively less time to train a model (based on a collection of data including relatively less data), a relatively faster training time, a relatively less complex model, relatively less computational resources being needed, etc. For example, in response to a determination that an object of interest is not captured with the correct angle, the inspection mission may cause the image to be captured again from a different angle and upload only the correct image (filtering out images that were not captured correctly). Accordingly, a relatively refined inspection collected data set is generated and uploaded to the cloud site as part of an AI processing pipeline. For context, in various approaches below, the “AI processing pipeline” starts from collecting data at an edge (by an edge device), uploading a subset of the data to the cloud and analyzing the data to detect insights about the data, e.g., whether an object has defects, whether an object has no defects, which defects, where are the defects, etc.

In some approaches, an edge spoke is added to the edge device and/or in communication with the edge device (as a second edge device). The edge spoke may be used in order to perform a feedback-control loop at the edge and validate that the data that is sent out from edge, e.g., either edge device or edge spoke depending on the approach, to the cloud site matches a set of predefined AI requirements. As will be described in greater detail elsewhere below, these techniques have, during testing, proven to maintain an accuracy of the model, while improving a plurality of key performance indicators (KPIs).

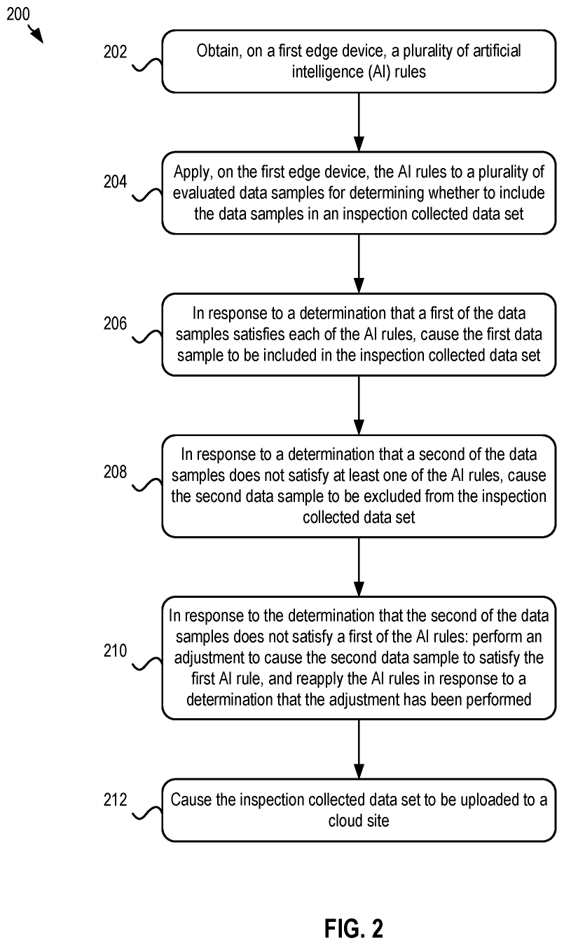

Now referring to FIG. 2, a flowchart of a method 200 is shown according to one approach. The method 200 may be performed in accordance with the present invention in any of the environments depicted in FIGS. 1-13, among others, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by an edge device, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that in some preferred approaches, method 200 may be performed by a device, e.g., preferably an edge device, that is configured to evaluate and/or obtain a plurality of data samples, e.g., images, thermal samples, audio clips, videos, etc. In some of such approaches, the edge device may be a roaming edge device (RED) that may, in some approaches, be defined as a device with the ability to sense an environment that the edge device is physically located in (possibly across multiple modalities). The edge device is, in some preferred approaches, additionally able to physically move, e.g., autonomously move, move based on received user guidance input, etc. Furthermore, in some approaches, the edge device is additionally a device that is configured to optionally execute computational workloads onboard. According to some non-limiting approaches, the RED devices may include, e.g., a drone, a mobile robot with sensor devices and analytics, autonomous cars, a handheld mobile device that is configured to present narration instructions for causing the handheld mobile device to be moved, etc.

Operation 202 includes obtaining, on a first edge device, a plurality of AI rules. In some preferred approaches, the AI rules are determined and generated by another device and loaded to the edge device along with an inspection mission. For context, the “inspection mission” may include any type of instructions that specify how the AI rules are to be applied by the first edge device. For example, the inspection mission may include instructions that specify that the plurality of received AI rules are to be applied to a plurality of data samples in order to determine an inspection collected data set of evaluated data samples that satisfy each of the AI rules. Instructions of the received inspection mission may additionally and/or alternatively specify a type of data samples that the AI rules are to be applied to, e.g., images, thermal readings generated by one or more predetermined sensors, sound samples, etc.

In some preferred approaches, the AI rules are based on images based on the data samples being images. In other words, in one or more of such approaches, the evaluated data samples are potential images that are actively being evaluated through a camera of the edge device but have not yet been captured by the camera, e.g., a potential image capture. For example, the data samples may be a perspective of a camera of the edge device is currently pointed at and viewing, where the perspective of the camera has not been captured, e.g., a picture has not yet been taken by the first edge device. However, in some other approaches, the techniques described herein may be implemented where an image has already been captured. For example, in one or more of such approaches, for a captured image, the image may be analyzed using the techniques described herein. In response to a determination, based on results of the analysis, that contents of the image do not satisfy one or more of the predetermined AI rules, an instruction may be issued, e.g., to an automated camera that captured the image, to go back and recapture the image in a different manner, while dropping the previous image.

A first of the AI rules that is based on a data sample that is an image may specify that the image being evaluated be captured from a predetermined ground sample distance (GSD) from an object of interest. In another approach, the second of the AI rules may specify that a predetermined object to background ratio must be met. In yet another approach, a third of the AI rules may specify that a predetermined lighting condition is met, e.g., at least a threshold extent of light is detected in a sensor of the camera of the first edge device, etc. In another approach, a fourth of the AI rules may specify that an object of interest is centered in the image being evaluated, e.g., at least 50% of the object of interest is within a center of the image. In yet another approach, a fifth of the AI rules may specify that the object of interest is focused in the image being evaluated, e.g., only non-blurry images are allowed.

As a result of obtaining the plurality of AI rules, the AI rules are ready to be applied to determine whether or not to capture potential data samples, e.g., evaluated data samples. Without such AI rules, the data samples that are uploaded to a predetermined cloud site are otherwise allowed to include contents that are not beneficial to obtaining insights on the captured data, e.g., for finding defects in the object(s) of interest.

It should be noted that, although various of the rules described above are based on data samples that are images, in some other approaches, at least some of the rules may additionally and/or alternatively be based on other types of data samples. For example, in some approaches, the data samples may additionally and/or alternatively be a thermal reading. In some approaches, AI rules that are based on thermal readings may be obtained, e.g., minimum threshold thermal reading values, maximum threshold thermal reading values, etc. According to yet another example, the data samples may additionally and/or alternatively be a potential audio clip. In some approaches, AI rules that are based on potential audio clips may be determined, e.g., to include audio having at least a predetermined pitch, to include audio having at least a predetermined frequency, to include audio having no more than a predetermined frequency, etc. Other image based AI rules and/or thermal reading based AI rules and/or audio sample based AI rules that would be apparent to one of ordinary skill in the art after reading the descriptions herein may be used.

Having AI rules based on more than one type of data sample may, in some approaches, increase the number of use case scenarios that the first edge device is able to be deployed in. Furthermore, having AI rules based on more than one type of data sample may additionally and/or alternatively allow relatively richer data samples that satisfy the AI rules to be captured and thereafter used to obtain insights on the captured data.

Operation 204 includes applying, on the first edge device, the AI rules to a plurality of evaluated data samples for determining whether to include the data samples in an inspection collected data set. For context, in some preferred approaches, only data samples that are determined to satisfy all of the AI rules make up the inspection collected data set. These data samples, for example, may be images that are captured during inference, e.g., during an inspection mission (for example, inspection of solar panels). In some of these approaches, these images are not used for training at this point, but rather for purposes of performing an inspection. For example, such an inspection may be performed for finding defects in the object(s) of interest, or more specifically, in the above example, finding a crack in a solar panel. For further context, in some approaches, the data samples caused to be included in the inspection collected data set are not used for training of the model that analyzes them. However, in some approaches, these images may be used for training a predetermined AI model in a next cycle, e.g., after the inspection mission performed for determining the inspection collected data set is completed. For example, subsequent to the inspection collected data set being uploaded to a cloud site, the images of current inspection mission may be used for training a predetermined AI model that will be used to perform analysis for a next inspection mission (thereby improving the model between iterations).

Applying the AI rules to a plurality of evaluated data samples, in some approaches, includes determining whether each of the evaluated data samples satisfy each of the AI rules. In some approaches, the AI rules are sequentially applied to the first data sample. This way, in response to a determination that the first data sample does not satisfy one of the AI rules, processing of the other rules is not unnecessarily performed, e.g., not performed in the event that the first sample is excluded from the inspection collected data set as a result of the AI rule not being satisfied and/or not performed until a determination is made that the first data sample satisfies the AI rule as a result of an adjustment being performed. In contrast, in some other approaches, the AI rules may be applied in parallel to one or more of the data samples. Parallel application of the AI rules allows for streamlined processing of data samples and furthermore, streamlined generation of the collection of the data.

With respect to data samples that are images, in some approaches, applying an AI rule of the AI rules to one of the data samples includes performing image processing and/or analysis techniques that would be apparent to one of ordinary skill in the art after reading the descriptions herein. Results of performing the image processing and/or analysis techniques may include characterizations of the image, e.g., lighting characterizations, focus characterizations, relative distance characterizations, etc., and one or more of the characterizations may be compared with an associated one of the AI rules. For example, in some approaches, an illustrative comparison may include comparing lighting characterizations of a potential image to one or more predetermined thresholds of one of the AI rules that is based on a predetermined lighting condition being met.

As a result of applying the AI rules to the plurality of evaluated data samples, data samples that are determined to be beneficial for analyzing the object of interest, e.g., data sample(s) that satisfy each of the AI rules, are identified and optionally included in the inspection collected data set. For example, in response to a determination that a first of the data samples satisfies each of the AI rules, the first data sample is caused to be included in the inspection collected data, e.g., see operation 206. In order to cause the first data sample to be included in the inspection collected data, in some approaches, in response to the determination that the first of the data samples satisfies each of the AI rules the first edge device captures the potential data sample. For example, in one or more of such approaches, the first edge device captures the first data sample in a current view of the camera of the first edge device. In some approaches in which method 200 is being performed by the first edge device, the first edge device performs the capture in response to the determination that the first of the data samples satisfies each of the AI rules. In some other approaches, the first edge device may be an edge spoke. For context, in such approaches, the first edge device is a “spoke” edge device based on the first edge device performing operations of method 200 for another edge device, e.g., a second edge device that offloads processing operations to the first edge device. For example, in one or more of such approaches, the second edge device may be using a camera viewing the data samples, but operations of method 200 may be performed for the second edge device by the first edge device, e.g., in response to a determination the second edge device does not have at least a predetermined threshold amount of processing resources. The first edge device may thereby receive information about the data samples from the second edge device, perform the determinations of whether to include data samples in the inspection collected data, and based on the determinations, cause the second edge device to exclude the data samples from the inspection collected data set or include the data samples in the inspection collected data set. Accordingly, the first edge device may determine whether the first data sample satisfies the AI rules, and in response to a determination that the first data sample satisfies each of the AI rules, the first edge device causes the first data sample to be included in the inspection collected data set. In the use case in which the first edge device is an edge spoke, method 200 includes outputting an instruction to the second edge device to capture the first data sample.

Causing data samples determined to satisfy each of the AI rules to be included in the inspection collected data set ensures that the inspection collected data set includes data samples that are worth expending processing resources on, e.g., such as processing resources used to upload the inspection collected data set to a cloud site. As a result of achieving the relative reductions described above, relatively less data is computed and output. This results in a less data being transferred from edge sites to cloud sites, which results in a relatively faster processing of data samples, and relatively less computational resources being consumed.

In one approach, the second edge device may include a plurality of swarm robots that each include at least one camera and operate together to establish a meshed image, e.g., an image made up of a plurality of different sub-images each viewed by a different one of the swarm robots. In such an approach, characteristics of the image may be output from at least one of the swarm robots to the first edge device.

In contrast, data samples that would not otherwise relatively enrich the inspection collected data set, e.g., data sample(s) that do not satisfy each of the AI rules, are preferably identified and optionally excluded from the inspection collected data set. This enables the inspection collected data set to be relatively condensed, which results in relatively less processing resources being expended by the first edge device than would otherwise be expended in capturing, processing and outputting data samples that do not enrich the inspection collected data set. For example, operation 208 includes causing a second data sample to be excluded from the inspection collected data set in response to a determination that the second of the data samples does not satisfy at least one of the AI rules. It may be noted that although some preferred approaches call for all of the AI rules to be satisfied by a given data sample in order for the given data sample to be included in the inspection collected data set, in some other approaches, a predetermined extent of the AI rules may be satisfied by the given data sample in order for the given data sample to be included in the inspection collected data set, e.g., a majority of the AI rules, at least some predetermined AI rules of the plurality of AI rules, etc.

In some approaches, in response to a determination that the second of the data samples does not satisfy at least a first of the AI rules, one or more operations may be performed in an attempt to cause the second data sample to satisfy the one or more AI rules that the second data sample has been determined to not satisfy. For purposes of an example, an assumption may be made that the second data sample does not satisfy a first AI rule. In response to the determination that the second data sample does not satisfy a first AI rule, method 200 may include performing an adjustment to cause the second data sample to satisfy the first AI rule, e.g., see operation 210. In some approaches, these adjustments include, e.g., causing a repositioning of the first edge device with respect to an object of interest in the second data sample, applying a filter to a camera of the first edge device, adjusting a focus of the camera of the first edge device, etc. These adjustments may advantageously enable the second data sample to conform to all of the AI rules in order to allow incorporation of the updated second data sample, e.g., the second data sample subsequent to the adjustment(s) being performed, to the inspection collected data set. In response to a determination that the adjustment(s) have been performed, at least the AI rules that were previously determined to not satisfy the second data sample may be reapplied to the updated second data sample. For context, the updated second data sample preferably includes a majority of the same image contents as the first data sample, although one or more of the contents may be repositioned and/or omitted from the updated second data sample.

In one use case example in which the first edge device is a user device, in response to the determination that the second of the data samples does not satisfy a first of the AI rules, a first suggested adjustment is output to a display of the user device. Thereafter, in response to a determination that an attempt has been made to perform the first suggested adjustment, the AI rules may be reapplied to the updated second data sample. In some approaches in which a plurality of rules are determined to not be satisfied, a plurality of associated suggested adjustments are output. For example, the suggested adjustments may include descriptive narrations detailing how to satisfy one or more of the AI rules, e.g., changing a ground sample distance (GSD) from an object of interest, centering the object of interest within a bounding box, selecting the object of interest on the display of the first edge device, etc.

Subsequent to performing one adjustment and up to a plurality of adjustments, at least some data samples, e.g., the second data sample, may be determined to still not satisfy at least one of the AI rules. In response to a determination that such data samples still do not satisfy at least one of the AI rules after the adjustment(s) are performed, the data samples determined to not satisfy at least one of the AI rules are excluded from the inspection collected data set. In some approaches, these data samples are excluded from the inspection collected data set as a result of the first edge device selectively not using the camera of the first edge device to capture the data samples that are to be excluded. In some other approaches in which the first edge device is an edge spoke for a second edge device, these data samples are excluded from the inspection collected data set by issuing, from the first edge device to the second edge device, an instruction to not image capture the data samples that are to be excluded from the inspection collected data set.

Data samples that are determined to satisfy each of the AI rules may, in some approaches, be added to the inspection collected data set until a predetermined threshold condition is determined to be met, e.g., a predetermined number of data samples are added to the inspection collected data set, an indication is received that the collected images are sufficient for detecting the predetermined defects, etc. In some other approaches, the predetermined threshold condition includes a determination being made that a battery of the first edge device is approaching a minimum percentage that uploading the current inspection collected data set will take before being depleted.

Operation 212 includes causing the inspection collected data set to be uploaded to a cloud site. In some approaches in which the first edge device is an edge spoke for the second edge device, causing the inspection collected data set to be uploaded to the cloud site includes outputting an instruction to the second edge device to upload the inspection collected data set to the cloud site using upload techniques that would become apparent to one of ordinary skill in the art after reading the descriptions herein. In contrast, in some approaches in which the first edge device is not an edge spoke for another edge device, the inspection collected data set is uploaded to the cloud site by the first edge device. Techniques that would become apparent to one of ordinary skill in the art after reading the descriptions herein may be used for uploading the inspection collected data set.

As a result of refining the data samples that are included in the inspection collected data set, the contents of the data samples that are included in the inspection collected data set are vetted to satisfy the predetermined AI rules. Processing resources of the edge device and the cloud site are preserved as a result of deploying the techniques described herein because the amount of data that is ultimately uploaded from the first edge device to the cloud site is relatively decreased as a result of excluding at least some data samples determined to not satisfy at least one of the AI rules from the inspection collected data set. It should be noted that the processing resources expended in order to apply the AI rules have, during testing of techniques described herein, been found to be relatively less than the processing resources expended in order to send an unrefined inspection collected data set to the cloud site. This relatively refined inspection collected data set also enables a relatively increased upload speed of the inspection collected data set, based on relatively less data being uploaded. Of course, all of these benefits ultimately cause relatively less data being processed and computed at the cloud site, which results in at least some processing resources that would otherwise be consumed processing the inspection collected data set being preserved, and costs associated with this processing being saved.

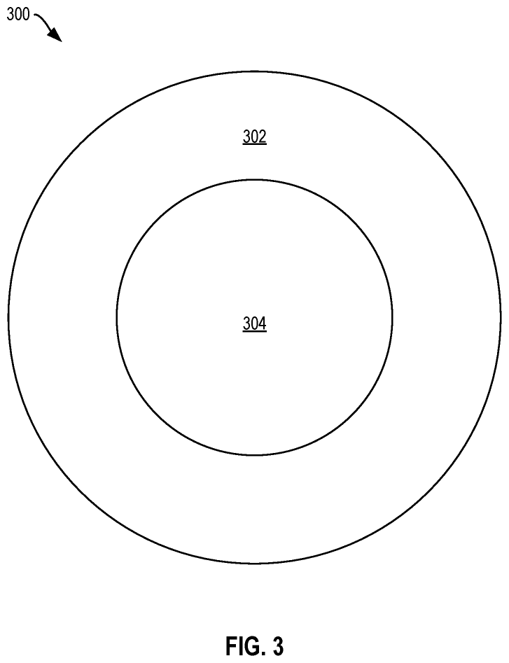

FIG. 3 depicts a comparative overlay 300, in accordance with one approach. As an option, the present comparative overlay 300 may be implemented in conjunction with features from any other approach listed herein, such as those described with reference to the other FIGS. Of course, however, such comparative overlay 300 and others presented herein may be used in various applications and/or in permutations which may or may not be specifically described in the illustrative approaches listed herein. Further, the comparative overlay 300 presented herein may be used in any desired environment.

The comparative overlay 300 illustrates the performance benefits described above that result from applying AI rules to determine the inspection collected data set uploaded to a cloud site during an inspection mission performed by an edge device. Specifically, the comparative overlay 300 illustrates that a relatively larger data set 302 may be refined to a relatively smaller data set 304 by applying the AI rules. For context, the relatively larger data set 302 includes at least some data samples that do not satisfy at least one of the AI rules, while such data samples are excluded from the relatively smaller data set 304.

One use case for refining the relatively larger data set 302 to the relatively smaller data set 304 may be based on a company that wants to define a new AI pipeline, with the purpose of an inspection mission that is done on a regular basis, e.g., daily, weekly, monthly, etc. The AI pipeline may, in some approaches, be at least initially defined based on input received, by a first edge device, from a user device of the company. This input may be received in response to questions being previously output by the first edge device to the user device that requests input with respect to what a purpose of the AI pipeline is, or in other words, what an AI model is to look for in the inspections, e.g., cracks and/or defects in bridges, defects in fire extinguishers, etc.

The design of the AI pipeline may start with defining AI rules for the pipeline based on the input received on the first edge device. For context, a primary purpose of these AI rules is to validate that the AI model running at the end of the pipeline will be able to detect conditions that the AI model is designed to detect for, with a relatively high accuracy. Examples of these AI rules include, e.g., an image being evaluated being captured from a predetermined GSD from an object of interest, a predetermined object to background ratio being met, a predetermined lighting condition being met, the object of interest being centered in the image being evaluated, the object of interest being focused in the image being evaluated, etc.

With the AI rules defined, the AI rules are, in some preferred approaches, then translated into code that can run on the first edge device, e.g., relatively lightweight code, based on a computer vision and a lightweight object detection model. The lightweight object detection model is configured to run at an edge site of the first edge device and given an image, can use the input to return back a bounding box of the object(s) of interest.

In some approaches, in order to apply each of the AI rules to a plurality of data samples, a data quality detector may be used, e.g., deployed on the first edge device. The data quality detector may be mapped one-to-one to an AI rule. The data quality detector may be a code that, when executed, checks whether or not the AI rule is satisfied in a given data sample, e.g., an image. In response to a determination that at least one of the AI rules are not satisfied for the given data sample, insights may be generated by the first edge device that detail how to perform an adjustment to satisfy the AI rule(s) that are not satisfied.

In one example, given a lightweight object detection model that analyzes an image and returns a bounding box of an object in the image, a detector may be code that obtains an image, checks an object to background ratio in the image, and generates a suggestion such as moving a camera of the first edge device relatively closer to the object or moving a camera of the first edge device relatively further from the object in order to attain a ratio specified in one or more of the AI rules.

Once all AI rules have been defined and data quality detectors have been implemented, the first edge device may be instructed to begin collecting images for the inspection data set that will be used to obtain insights about the object(s) of interest using the AI model that detects defects at the end of the AI pipeline. The data quality detectors are used to check the images and validate that only images that satisfy all of the AI rules are part of the inspection collected data set. In one use case example, assuming that a first of the AI rules specifies that an object of interest is to be centered in an image, e.g., in the 50% center of the image, the detector may be used to check the data samples and filter out images that do not satisfy this AI rule. As a result of filtering out data samples that are images that do not satisfy at least one of the AI rules, a relatively smaller inspection collected data set is determined, e.g., a subset of the data set that would otherwise be generated without applying the AI rules.

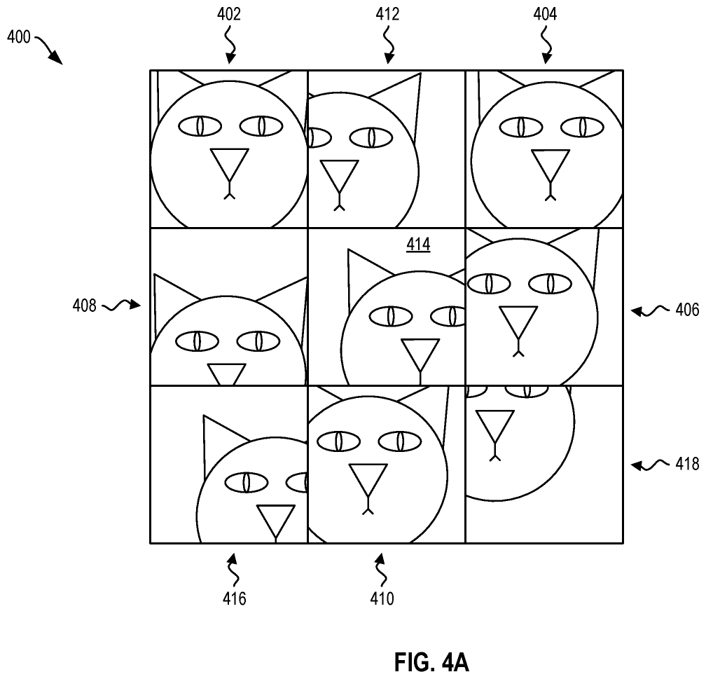

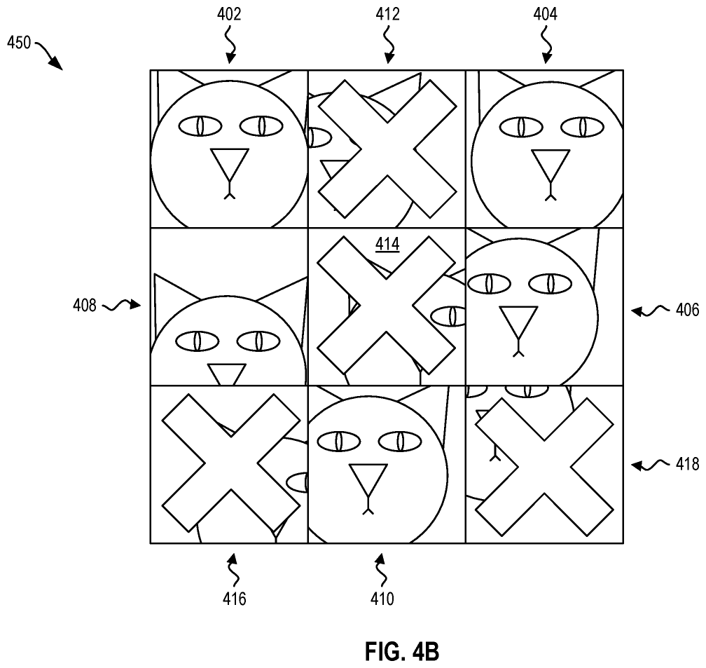

FIGS. 4A-4B depict data samples 400 and 450, in accordance with several approaches. As an option, the present data samples 400 and 450 may be implemented in conjunction with features from any other approach listed herein, such as those described with reference to the other FIGS. Of course, however, such data samples 400 and 450 and others presented herein may be used in various applications and/or in permutations which may or may not be specifically described in the illustrative approaches listed herein. Further, the data samples 400 and 450 presented herein may be used in any desired environment.

Referring first to FIG. 4A, the data samples 400 include a plurality of images of cats. Image analysis techniques that would become apparent to one of ordinary skill in the art after reading the descriptions herein may be used to analyze the images to determine whether one or more obtained AI rules are satisfied. For example, an assumption may be made that a first AI rule specifies that both eyes of the cat should be within a 50% center of the image. In image 402, image 404, image 406, image 408, and image 410, determinations may be made that the first AI rule is satisfied because in these images, both of the eyes of the cat are shown in about a center of the images. In contrast, in image 412, image 414, image 416 and image 418, determinations may be made that the first AI rule is not satisfied because in these images, both of the eyes of the cat are not shown in about a center of the images.

Referring now to FIG. 4B, in response to the determination that image 412, image 414, image 416 and image 418 do not satisfy the AI rule, the images are excluded from the inspection collected data set as data samples. This exclusion is performed to filter out the data samples that do not satisfy the AI rules, and thereby results in a relatively refined data set for analysis by the AI model. The captured data samples are preferably used for analyzing predetermined object(s) of interest, e.g., finding defects and/or determining insights about a specific location at which the data samples are captured. As part of a continuous improvement of the AI model, these data samples (e.g., images) of the inspection collected data set may be used for training of the AI model that is used a next time the inspection mission is triggered, e.g., a next iteration. For example, for a daily inspection that is performed, the AI model that is used in the inspection of a next day may be caused to receive the insights determined using the inspection collected data set. Processing resources of the edge device and the cloud site are also preserved as a result of deploying the techniques described herein because the amount of data that is ultimately uploaded from the first edge device to the cloud site is relatively decreased as a result of excluding at least some data samples determined to not satisfy at least one of the predetermined AI rules.

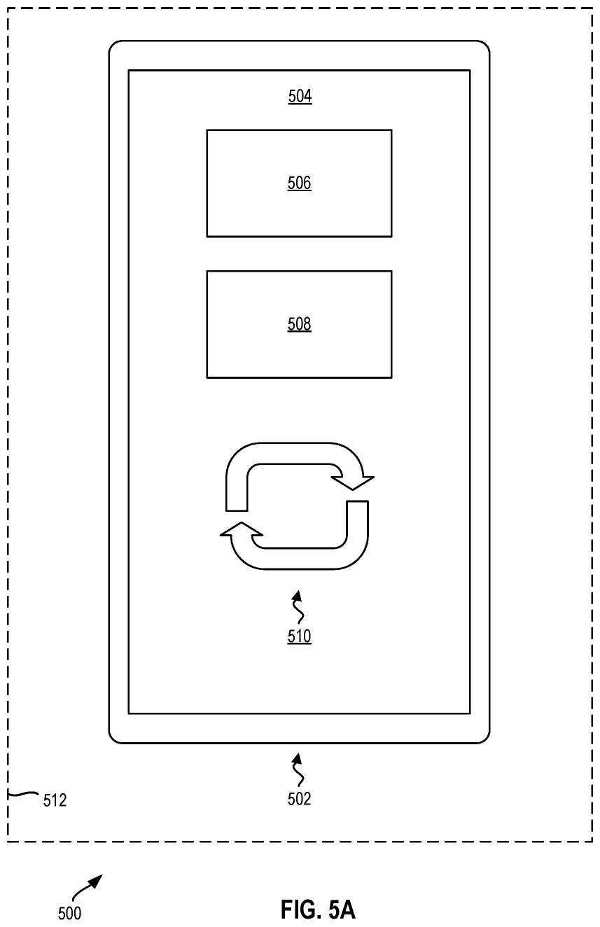

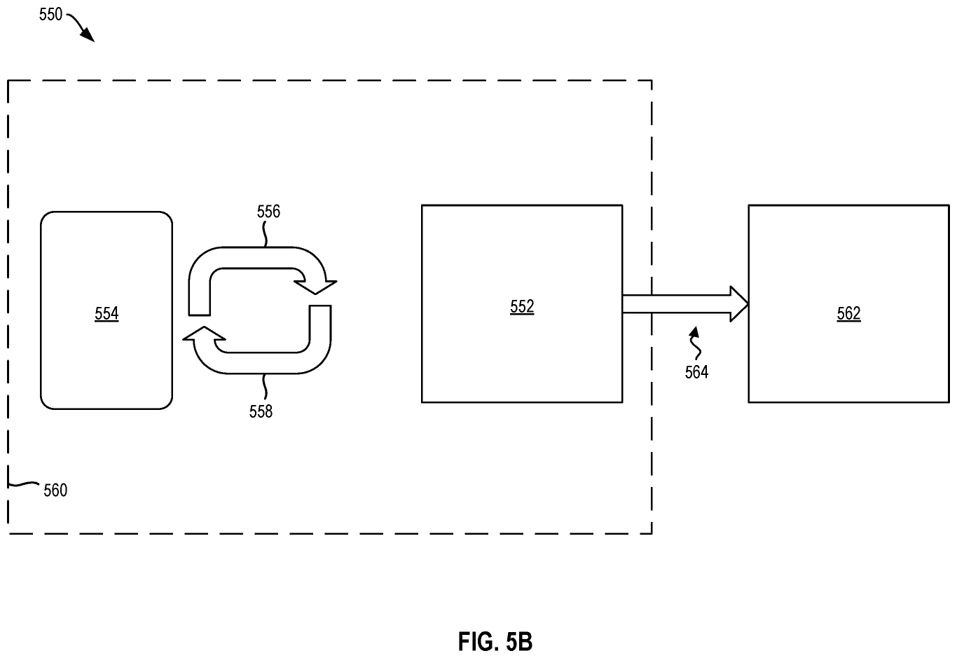

FIGS. 5A-5B depict systems 500 and 550, in accordance with several approaches. As an option, the present systems 500 and 550 may be implemented in conjunction with features from any other approach listed herein, such as those described with reference to the other FIGS. Of course, however, such systems 500 and 550 and others presented herein may be used in various applications and/or in permutations which may or may not be specifically described in the illustrative approaches listed herein. Further, the systems 500 and 550 presented herein may be used in any desired environment.

Referring first to FIG. 5A, the system 500 includes a first edge device 502 that is configured to perform operations for applying rules to determine an inspection collected data set to be uploaded to a cloud site. For example, in some preferred approaches, the first edge device includes a camera for viewing data samples that are images, and a display 504. The first edge device may additionally and/or alternatively include data quality detectors 506 that are each configured to apply a different obtained AI rule to data samples considered by the first edge device. In response to a determination that one or more of the data samples does not satisfy one or more of the AI rules, in some approaches, the first edge device includes logic 508 for determining and performing, e.g., see operation 510, adjustment(s) to cause the data samples to satisfy the AI rules. Thereafter the AI rules may be reapplied.

It should be noted that dashed contour 512 indicates that the first edge device does not rely on an external edge spoke to perform computational operations associated with applying the AI rules to data samples. Instead, the first edge device is configured to perform computational workloads onboard to determine an inspection collected data set that is thereafter uploaded to a cloud site.

Referring next to FIG. 5B, a first portion 560 of the system 550 includes a first edge device 552 that is configured to receive information and/or a data sample feed from a second edge device 554, e.g., see operation 556. In other words, the first edge device is an edge spoke for the second edge device. As a result of the first edge device applying obtained AI rules to a plurality of evaluated data samples, data samples that are determined to be beneficial for the analysis of the object(s) of interest, e.g., data sample(s) that satisfy each of the AI rules, are optionally included in the inspection collected data set. For example, in response to a determination that a first of the data samples satisfies each of the AI rules, the first data sample is caused to be included in the inspection collected data set. In order to cause the first data sample to be included in the inspection collected data set, in some approaches, in response to the determination that the first of the data samples satisfies each of the AI rules the first edge device instructs the second edge device 554 to capture the potential data sample, e.g., see operation 558.

The inspection collected data set is caused to be uploaded to a cloud site 562 via data upload pipeline 564. In some approaches, the inspection collected data set is uploaded by the first edge device. In some other approaches, the inspection collected data set is uploaded by the second edge device, e.g., based on an instruction issued from the first edge device to the second edge device.

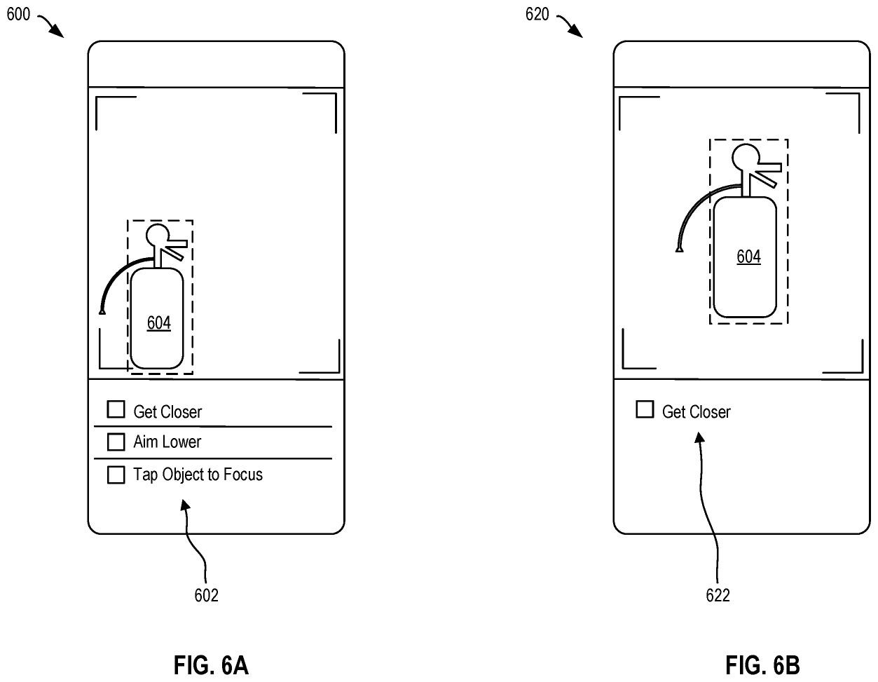

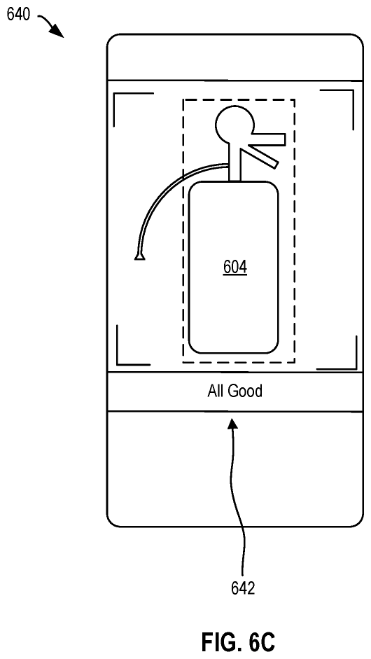

FIGS. 6A-6C depict edge device screenshots 600, 620 and 640, in accordance with several approaches. As an option, the present screenshots 600, 620 and 640 may be implemented in conjunction with features from any other approach listed herein, such as those described with reference to the other FIGS. Of course, however, such screenshots 600, 620 and 640 and others presented herein may be used in various applications and/or in permutations which may or may not be specifically described in the illustrative approaches listed herein. Further, the screenshots 600, 620 and 640 presented herein may be used in any desired environment.

In some approaches, once an AI model that detects defects is ready to be used and before executing inspection missions, one or more edge devices, such as a spoke/gateway, may be deployed at an edge. For example, an edge device may run the code that validates whether images satisfy AI rules, e.g., during a data acquisition process for a feedback loop. A first edge device may be used to apply the set of AI rules. In response to a determination that an image does not satisfy one or more of the AI rules, the image is not captured and one or more adjustments may be performed and/or suggested in an attempt to cause the image to satisfy the AI rules. FIGS. 6A-6C illustrate a visualization example for a scenario in which, during these inspection missions, in real time, images are analyzed and only images that satisfy the AI rules are captured for further analysis. More specifically, FIGS. 6A-6C depict how an application on the mobile first edge device provides instructions to adapt a positioning of the first edge device in order to satisfy the AI requirements.

Referring first to FIG. 6A, the first edge device may determine that a first data sample, e.g., an image with an object of interest 604 that includes a fire extinguisher, does not satisfy a plurality of the AI rules. For example, a perspective of the image may be determined to position the object of interest too low with respect to a first of the AI rules, too far out with respect to a second of the AI rules and out of focus with respect to a third of the AI rules. More specifically, these AI rules may specify that: the fire extinguisher must be in focus (a primary concern is not about the focus of the whole image, just of the object of interest), the fire extinguisher should be at the center of the image, and the fire extinguisher image should be taken from a defined distance, e.g., resulting in an object/background predetermined desired ratio while not using zoom of a camera of the first edge device. In response to a determination that the AI rules are not satisfied, in some approaches, for each of the AI rules determined to not be satisfied, a suggested adjustment is output to a display of the first edge device, e.g., see suggested adjustments 602.

Referring now to FIG. 6B, the object of interest has been centered and focused to satisfy two of the AI rules, however, a determination is made that the object of interest is still too small in the image, and therefore one of the suggested adjustments 622 is output to the display of the first edge device.

Referring now to FIG. 6C, a determination is made that the image satisfies all of the AI rules and therefore a confirmation 642 is output to the display of the first edge device to instruct that the image can be captured.

In some use cases, the first edge device is a programmable robot, and therefore the adaptations may be performed automatically. In some other use cases, the first edge device is a mobile device, and therefore the suggested adjustments are output to instruct a user of a positioning of the first edge device that will satisfy the AI rules. Examples of such use cases include a mobile device such as a phone or tablet being used to perform an inspection mission in a manufacturing plant. The inspection mission includes taking images of all fire extinguishers in the manufacturing plant. In such a use case, images that are ultimately captured in response to a determination that the AI rules are satisfied in the image, may be saved on the mobile device during the inspection mission and uploaded to the cloud site once the mobile device returns to a base station.

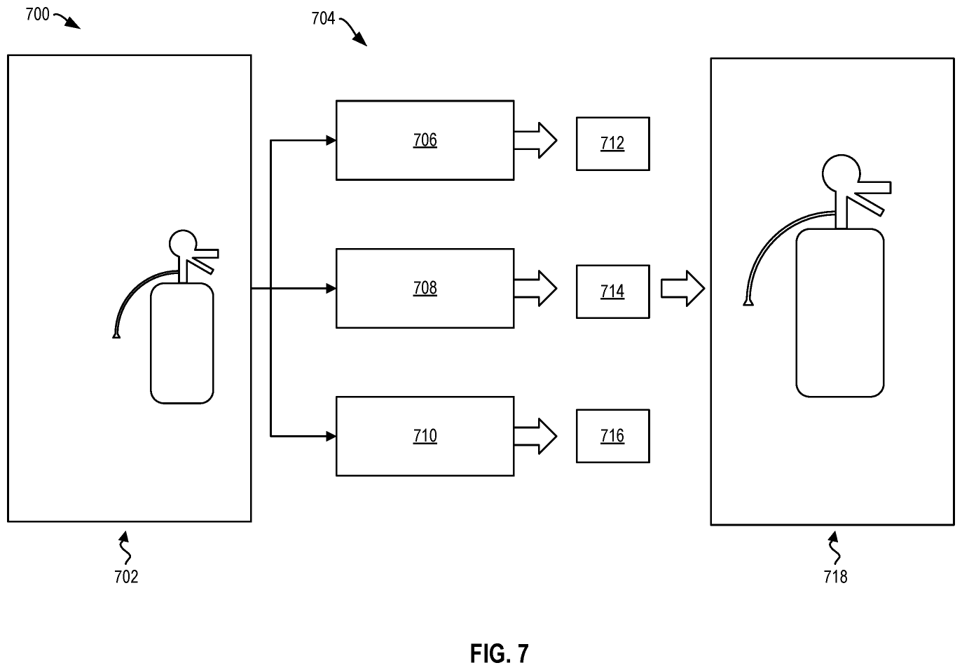

FIG. 7 depicts a schematic 700 of AI rules being applied to data samples, in accordance with one approach. As an option, the present schematic 700 may be implemented in conjunction with features from any other approach listed herein, such as those described with reference to the other FIGS. Of course, however, such schematic 700 and others presented herein may be used in various applications and/or in permutations which may or may not be specifically described in the illustrative approaches listed herein. Further, the schematic 700 presented herein may be used in any desired environment.

The schematic 700 illustrates a plurality 704 of AI rules being applied to a first data sample 702 in parallel. For example, a first AI rule 706, a second AI rule 708 and a third AI rule 710 are each applied to determine whether to include the first data sample in an inspection collected data set. In some approaches, a plurality of suggested adjustments 712, 714 and 716 are made and/or output in response to a determination that the first data sample does not satisfy an associated one of the AI rules. Based on these adjustments, an updated first data sample 718 may be determined to satisfy each of the AI rules, and thereby be included in the inspection collected data set.

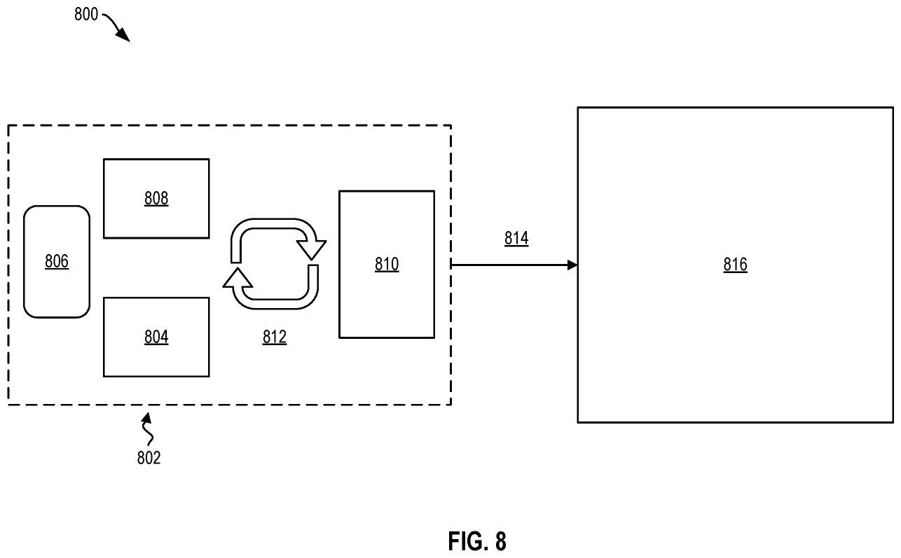

FIG. 8 depicts a system 800 for applying rules to determine an inspection collected data set uploaded to a cloud site, in accordance with one approach. As an option, the present system 800 may be implemented in conjunction with features from any other approach listed herein, such as those described with reference to the other FIGS. Of course, however, such system 800 and others presented herein may be used in various applications and/or in permutations which may or may not be specifically described in the illustrative approaches listed herein. Further, the system 800 presented herein may be used in any desired environment.

The system 800 includes a plurality 802 of edge devices. For example, edge device 804, edge device 806 and edge device 808 may relay streams of data samples to an edge spoke 810 that is configured to execute code to determine whether the data samples satisfy AI rules. In some approaches, suggested adjustments may be returned, e.g., see operation 812, to one or more of the edge devices in response to a determination that one or more of the data samples do not satisfy the AI rules. Data samples determined to satisfy the AI rules are added to an inspection collected data set that is uploaded to a cloud site 816 via data upload pipeline 814.

To summarize, the operations performed in the system 800 introduce control at a data-acquisition stage, employing computer-vision and/or lightweight AI algorithms to ensure compliance with pre-defined AI rules. This compliance is enabled through testing features of the captured data, and adjusting the acquisition means as needed. One essence of these operations can be found at the edge device, whereby conditions are defined and enforced on the data acquisition process, end-of-pipe AI model requirements are guaranteed to be satisfied, and inference data is guaranteed to fall within the space defined by the predetermined AI rules.

FIG. 9 depicts an environment 900, in accordance with one approach. As an option, the present environment 900 may be implemented in conjunction with features from any other approach listed herein, such as those described with reference to the other FIGS. Of course, however, such environment 900 and others presented herein may be used in various applications and/or in permutations which may or may not be specifically described in the illustrative approaches listed herein. Further, the environment 900 presented herein may be used in any desired environment.

Although various approaches described herein describe AI rules being applied to still images that may thereafter be captured, in some other approaches, the AI rules may additionally and/or alternatively be applied to real-time video streams. For example, the environment 900 includes an edge device 902 mounted in a car traveling down a road. Video capturing is a convenient way of capturing large volumes of data. However, not all captured data may be considered relevant for inspection mission data that should be analyzed by an AI model. For example, in some applications, objects of interest occur sparsely. These applications may be applicable in an offline fashion, where data is collected, transferred, and processed elsewhere. However, the occurring overheads turn such an approach inefficient, based on a relatively large bandwidth consumption during data transfers, relatively large storage requirements, and relatively slow offline processing times. Accordingly, AI rules may be applied to a video stream to identify snippets of the video feed for including in an inspection collected data set. For example, traffic sign inspection may be a mission that is performed to locate defects in traffic signs. In scenarios in which the inspection is performed using a vehicle with cameras, techniques described herein may be used to generate an inspection collected data set that is analyzed by an AI model to identify the defects, or lack of defects, autonomously.

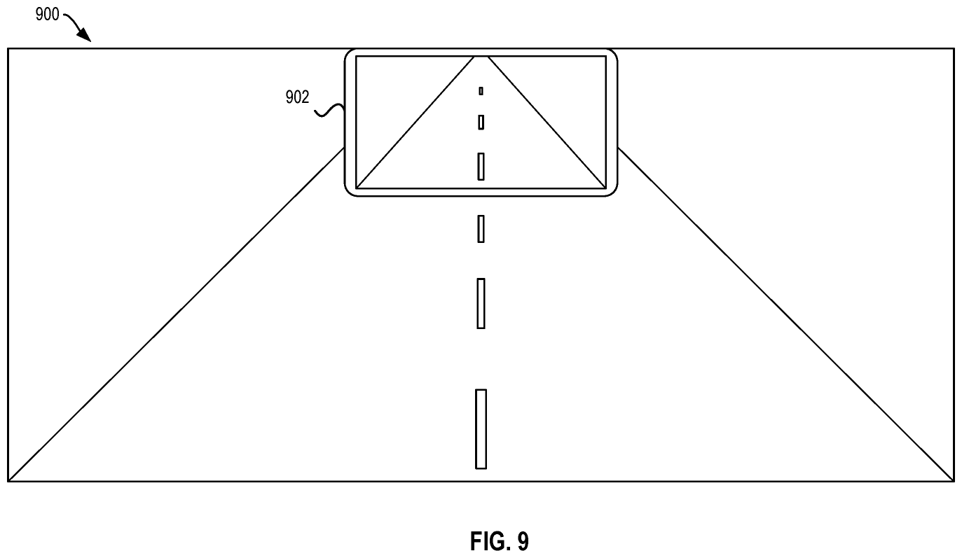

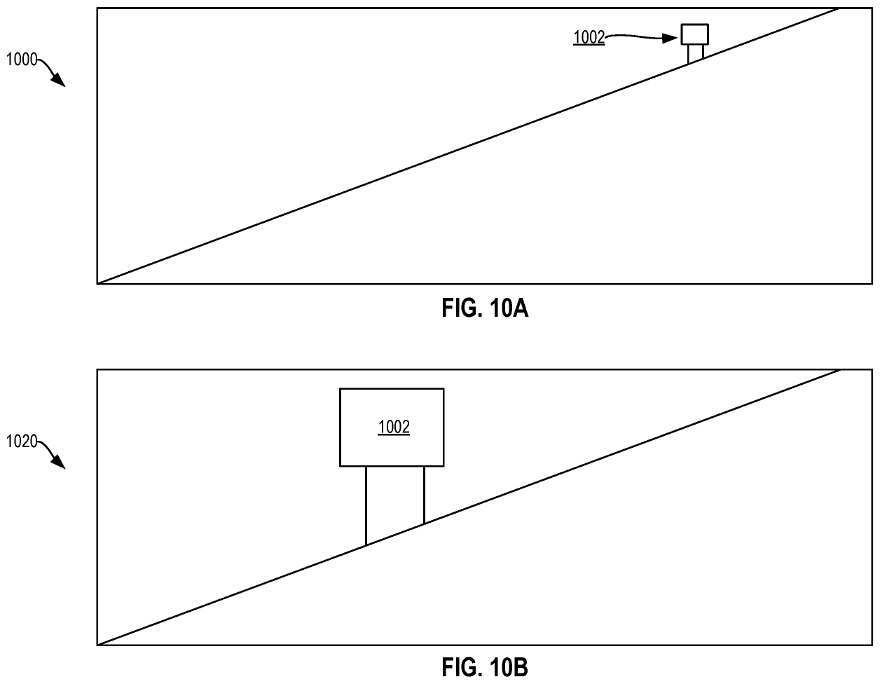

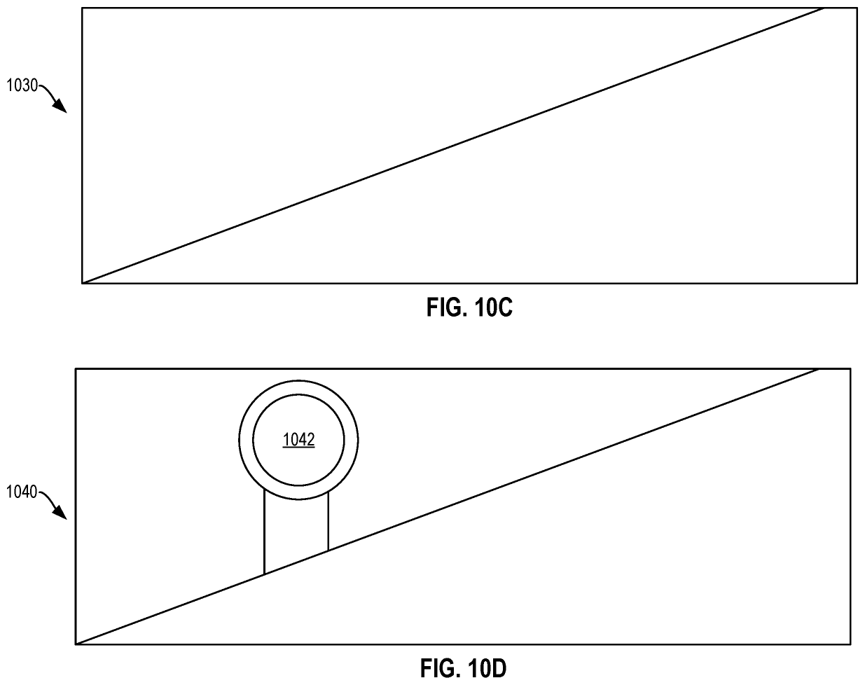

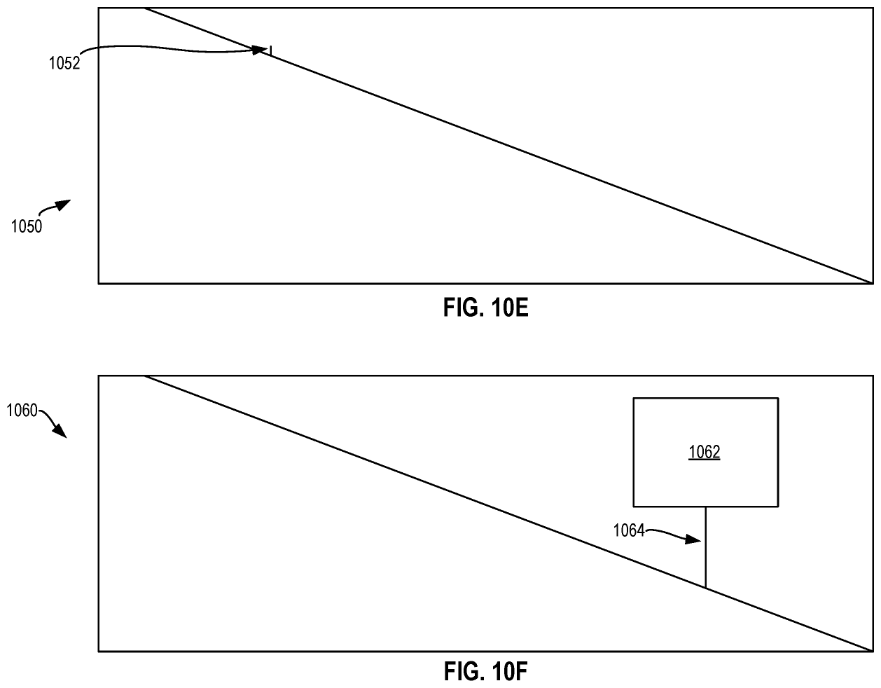

FIGS. 10A-10F depicts data samples 1000, 1020, 1030, 1040, 1050 and 1060, in accordance with several approaches. As an option, the present data samples 1000, 1020, 1030, 1040, 1050 may be implemented in conjunction with features from any other approach listed herein, such as those described with reference to the other FIGS. Of course, however, such data samples 1000, 1020, 1030, 1040, 1050 and others presented herein may be used in various applications and/or in permutations which may or may not be specifically described in the illustrative approaches listed herein. Further, the data samples 1000, 1020, 1030, 1040, 1050 presented herein may be used in any desired environment.

It may be prefaced that FIGS. 10A-10F depict various data samples that do not satisfy AI rules, and updated data samples that satisfy the AI rules as a result of adjustments being performed using various techniques described herein. Data samples that are determined to satisfy the AI rules may be added to an inspection collected data set that is uploaded to a cloud site.

Referring first to FIG. 10A, the data sample 1000 includes a sign 1002 along a road. The data sample 1000 is determined to not satisfy at least some of the AI rules based on the sign 1002 being an object of interest that is not centered in data sample. Adjustments may be performed to obtain the data sample 1020 in FIG. 10B, in which the sign 1002 is centered, and therefore determined to satisfy the AI rules.

Referring next to FIG. 10C, the data sample 1030 includes a road that lacks an object of interest. The data sample 1030 is determined to not satisfy at least some of the AI rules based on the data sample not including an object of interest. Adjustments may be performed, e.g., a focus of a camera of a first edge device that is used to obtain the data sample 1030, to obtain the data sample 1040 in FIG. 10D, in which a sign 1042 may be considered an object of interest. The data sample 1040 may be determined to satisfy the AI rules and therefore is added to the inspection collected data set.

Referring next to FIG. 10E, the data sample 1050 includes a road that includes a signpost 1052, but does not include a sign. The data sample 1050 is determined to not satisfy at least some of the AI rules based on the data sample not including a sign. Adjustments may be performed, e.g., a focus of a camera of a first edge device that is used to obtain the data sample 1050, to obtain the data sample 1060 in FIG. 10F, which includes a sign 1062 atop a signpost 1064. The data sample 1060 may be determined to satisfy the AI rules and therefore is added to the inspection collected data set.

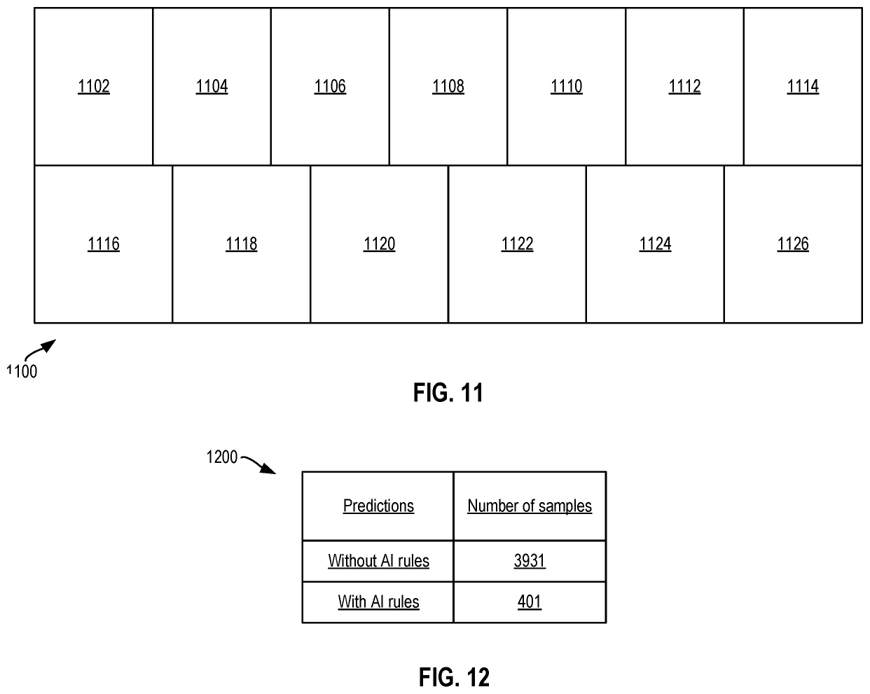

FIG. 11 depicts a collection of data samples 1100, in accordance with one approach. As an option, the present collection of data samples 1100 may be implemented in conjunction with features from any other approach listed herein, such as those described with reference to the other FIGS. Of course, however, such collection of data samples 1100 and others presented herein may be used in various applications and/or in permutations which may or may not be specifically described in the illustrative approaches listed herein. Further, the collection of data samples 1100 presented herein may be used in any desired environment.

Using the techniques described herein for applying AI rules, issues associated with traffic signs, e.g., many detectable detections of traffic signs in different data samples, may be sorted through in order to obtain an inspection collected data set. This application of AI rules may be particularly useful in use cases in which detection of the same traffic sign is analyzed over a plurality of data samples, e.g., where detection starts a relatively far off distance until the sign appears relatively closer in the data sample. An assumption may be made that the collection of data samples 1100 includes a plurality of data samples that are images of a traffic sign. Another assumption may be made that in the progression of the data samples, e.g., data sample 1102 to 1104 to 1106 to 1108 to 1110 to 1112 to 1114 to 1116 to 1118 to 1120 to 1122 to 1124 to 1126, a sign becomes relatively more in focus and centered based on adjustments performed to cause the data samples to satisfy the AI rules.

FIG. 12 depicts a table 1200, in accordance with one approach. As an option, the present table 1200 may be implemented in conjunction with features from any other approach listed herein, such as those described with reference to the other FIGS. Of course, however, such table 1200 and others presented herein may be used in various applications and/or in permutations which may or may not be specifically described in the illustrative approaches listed herein. Further, the table 1200 presented herein may be used in any desired environment.

Using the techniques described herein, Inventors observed one order of magnitude in improvement in terms of data volume. For example, as shown in table 1200, in a test case, a basic predictor which identifies traffic signs identified almost four thousand images, e.g., see 3931, while using the techniques described herein reduced the number of results added to an inspection collected data set to just over four hundred images, e.g., see 401, which constituted a surprising result. These improvements were achieved using various AI rules described herein including defining a distance from object of interest rule which directly reduced most of the non-relevant detections, e.g., in a subsequent detection of the same traffic sign, and an object-in-focus rule.

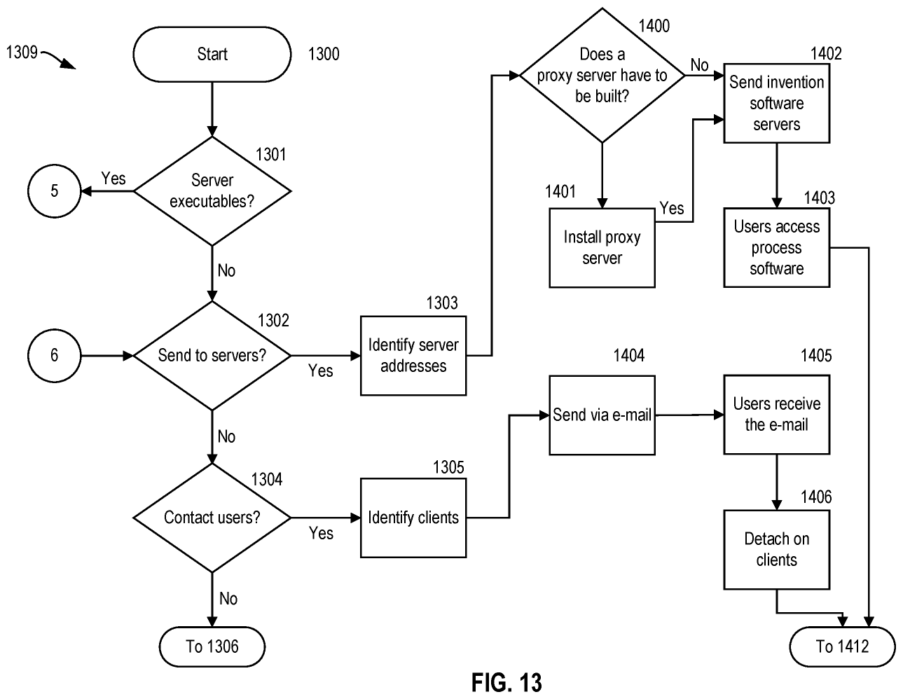

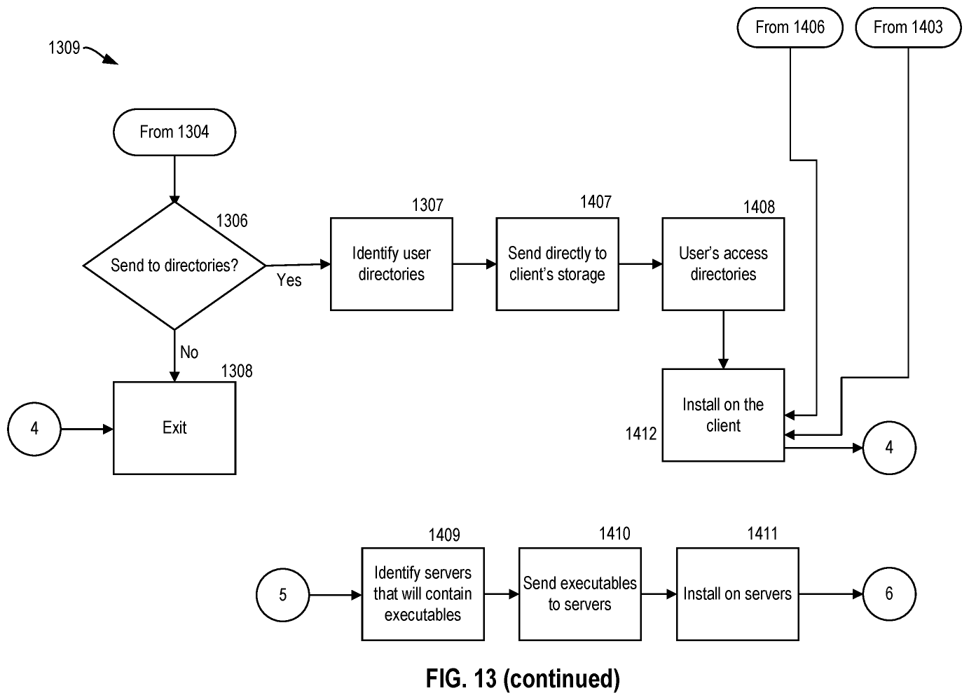

Now referring to FIG. 13, a flowchart of a method 1309 is shown according to one approach. The method 1309 may be performed in accordance with the present invention in any of the environments depicted in FIGS. 1-13, among others, in various approaches. Of course, more or fewer operations than those specifically described in FIG. 13 may be included in method 1309, as would be understood by one of skill in the art upon reading the present descriptions.

Each of the steps of the method 1309 may be performed by any suitable component of the operating environment. For example, in various approaches, the method 1309 may be partially or entirely performed by an edge device, or some other device having one or more processors therein. The processor, e.g., processing circuit(s), chip(s), and/or module(s) implemented in hardware and/or software, and preferably having at least one hardware component, may be utilized in any device to perform one or more steps of the method 1309. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software for applying rules during an inspection mission to determine an inspection collection data set for uploading to a cloud site may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 1300 begins the deployment of the process software. An initial step is to determine if there are any programs that will reside on a server or servers when the process software is executed (1301). If this is the case, then the servers that will contain the executables are identified (1409). The process software for the server or servers is transferred directly to the servers' storage via FTP or some other protocol or by copying though the use of a shared file system (1410). The process software is then installed on the servers (1411).

Next, a determination is made on whether the process software is to be deployed by having users access the process software on a server or servers (1302). If the users are to access the process software on servers, then the server addresses that will store the process software are identified (1303).

A determination is made if a proxy server is to be built (1400) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (1401). The process software is sent to the (one or more) servers either via a protocol such as FTP, or it is copied directly from the source files to the server files via file sharing (1402). Another approach involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (1403). Another approach is to have the servers automatically copy the process software to each client and then run the installation program for the process software at each client computer. The user executes the program that installs the process software on his client computer (1412) and then exits the process (1308).

In step 1304 a determination is made whether the process software is to be deployed by sending the process software to users via e-mail. The set of users where the process software will be deployed are identified together with the addresses of the user client computers (1305). The process software is sent via e-mail (1404) to each of the users' client computers. The users then receive the e-mail (1405) and then detach the process software from the e-mail to a directory on their client computers (1406). The user executes the program that installs the process software on his client computer (1412) and then exits the process (1308).

Lastly, a determination is made on whether the process software will be sent directly to user directories on their client computers (1306). If so, the user directories are identified (1307). The process software is transferred directly to the user's client computer directory (1407). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (1408). The user executes the program that installs the process software on his client computer (1412) and then exits the process (1308).

It will be clear that the various features of the foregoing systems and/or

methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method, comprising:
obtaining, on a first edge device, a plurality of artificial intelligence (AI) rules;
applying, on the first edge device, the AI rules to a plurality of evaluated data samples for determining whether to include the data samples in an inspection collected data set;
in response to a determination that a first of the data samples satisfies each of the AI rules, causing the first data sample to be included in the inspection collected data set; and
causing the inspection collected data set to be uploaded to a cloud site.

2. The computer-implemented method of claim 1, comprising: in response to a determination that a second of the data samples does not satisfy at least one of the AI rules, causing the second data sample to be excluded from the inspection collected data set.

3. The computer-implemented method of claim 2, comprising: in response to the determination that the second of the data samples does not satisfy a first of the AI rules: performing an adjustment to cause the second data sample to satisfy the first AI rule, and reapplying the AI rules in response to a determination that the adjustment has been performed.

4. The computer-implemented method of claim 1, wherein the evaluated data samples are images.

5. The computer-implemented method of claim 4, wherein the AI rules are selected from the group consisting of: the image being evaluated being captured from a predetermined ground sample distance from an object of interest, a predetermined object to background ratio being met, a predetermined lighting condition being met, the object of interest being centered in the image being evaluated, and the object of interest being focused in the image being evaluated.

6. The computer-implemented method of claim 1, wherein causing the first data sample to be included in the inspection collected data set includes outputting an instruction to a second edge device to capture the first data sample, wherein causing the inspection collected data set to be uploaded to the cloud site includes outputting an instruction to the second edge device to upload the inspection collected data set to the cloud site.

7. The computer-implemented method of claim 1, wherein causing the first data sample to be included in the inspection collected data set includes capturing, by the first edge device, the first data sample, wherein the inspection collected data set is uploaded to the cloud site by the first edge device.

8. The computer-implemented method of claim 1, wherein the AI rules are sequentially applied to the first data sample, wherein the AI rules are applied in parallel to a second of the data samples.

9. The computer-implemented method of claim 1, wherein a first of the evaluated data samples is an image, wherein a second of the evaluated data samples is selected from a group consisting of a thermal reading and an audio clip.

10. A computer program product, the computer program product comprising a computer readable storage medium having program instructions embodied therewith, the program instructions readable and/or executable by a first edge device to cause the first edge device to:
obtain, on the first edge device, a plurality of artificial intelligence (AI) rules;
apply, on the first edge device, the AI rules to a plurality of evaluated data samples for determining whether to include the data samples in an inspection collected data set;
in response to a determination that a first of the data samples satisfies each of the AI rules, cause the first data sample to be included in the inspection collected data set; and
cause the inspection collected data set to be uploaded to a cloud site.

11. The computer program product of claim 10, the program instructions readable and/or executable by the first edge device to cause the first edge device to: in response to a determination that a second of the data samples does not satisfy at least one of the AI rules, cause the second data sample to be excluded from the inspection collected data set.

12. The computer program product of claim 11, the program instructions readable and/or executable by the first edge device to cause the first edge device to: in response to the determination that the second of the data samples does not satisfy a first of the AI rules: perform an adjustment to cause the second data sample to satisfy the first AI rule, and reapply the AI rules in response to a determination that the adjustment has been performed.

13. The computer program product of claim 10, wherein the evaluated data samples are images.

14. The computer program product of claim 13, wherein the AI rules are selected from the group consisting of: the image being evaluated being captured from a predetermined ground sample distance from an object of interest, a predetermined object to background ratio being met, a predetermined lighting condition being met, the object of interest being centered in the image being evaluated, and the object of interest being focused in the image being evaluated.

15. The computer program product of claim 10, wherein causing the first data sample to be included in the inspection collected data set includes outputting an instruction to a second edge device to capture the first data sample, wherein causing the inspection collected data set to be uploaded to the cloud site includes outputting an instruction to the second edge device to upload the inspection collected data set to the cloud site.

16. The computer program product of claim 10, wherein causing the first data sample to be included in the inspection collected data set includes capturing, by the first edge device, the first data sample, wherein the inspection collected data set is uploaded to the cloud site by the first edge device.

17. The computer program product of claim 10, wherein the AI rules are sequentially applied to the first data sample, wherein the AI rules are applied in parallel to a second of the data samples.

18. The computer program product of claim 10, wherein a first of the evaluated data samples is an image, wherein a second of the evaluated data samples is selected from a group consisting of a thermal reading and an audio clip.

19. A system, comprising:
a processor; and
logic integrated with the processor, executable by the processor, or integrated with and executable by the processor, the logic being configured to:
obtain, on the first edge device, a plurality of artificial intelligence (AI) rules;
apply, on the first edge device, the AI rules to a plurality of evaluated data samples for determining whether to include the data samples in an inspection collected data set;
in response to a determination that a first of the data samples satisfies each of the AI rules, cause the first data sample to be included in the inspection collected data set; and
cause the inspection collected data set to be uploaded to a cloud site.

20. The system of claim 19, the logic being configured to: in response to a determination that a second of the data samples does not satisfy at least one of the AI rules, cause the second data sample to be excluded from the inspection collected data set.
